(19) United States
(12) Patent Application Publication
(10) Pub. No.: US 2024/0369172 A1
(43) Pub. Date: Nov. 7, 2024

(54) Segment for a Sensor-Carrier Body of a Pig for Inspecting a Pipeline

(71) Applicant: NDT Global Corporate Ltd., Dublin 9 (IE)

(72) Inventor: Maximilian Fischer, Woerth am Rhein (DE)

(21) Appl. No.: 18/291,185

(22) PCT Filed: Jul. 6, 2022
(86) PCT No.: PCT/EP2022/068696

§ 371 Date: Jan. 22, 2024

(30) Foreign Application Priority Data
Jul. 23, 2021 (EP) 21187463.1

(51) Int. Cl. F16L 55/40; F16L 101/30; G01N 29/22; G01N 29/265

(52) U.S. Cl. CPC F16L 55/40; G01N 29/225; G01N 29/265; F16L 2101/30; G01N 2291/106; G01N 2291/2636

(57) ABSTRACT

The present invention relates to a segment (16) for a sensor-carrier body (14) of a pig (10) for inspecting a pipeline (12), characterized in that the segment (16) has a supporting structure (18), on which at least one bar (20) including at least one ultrasonic transducer (22) is arranged, wherein the at least one bar (20) is releasably fastened to the supporting structure (18).

### TECHNICAL FIELD

The present application relates to a segment for a sensor-carrier body of a pig for inspecting a pipeline, and to the use thereof for pipeline inspection purposes.

### BACKGROUND

Pipelines are used in many sectors to transport fluids. To ensure that these are transported with as little loss as possible, it is essential not only to perform a final check of the pipeline after installation, but also to examine the pipeline for defects at certain intervals or after repair work, for example.

For this purpose, the pipeline to be examined may be non-destructively checked in-situ, for example by means of ultrasound or eddy current. During such a check, an arrangement of ultrasonic transmitters and sensors is mounted on a so-called pig and the pig is inserted into the line. The pig then runs through the pipeline and records the sensor signals as a function of the distance traveled, it being possible for the sensor signals to be analyzed immediately or at a later point in time (“In-Line Inspection”, ILI).

Such a pig may be driven independently and/or passively by a fluid flowing through the pipeline to be inspected. To this end, the pig may have, for example, one or more so-called cuffs, which are arranged on the circumference of the pig and are in contact with the inner wall of the pipeline. Such cuffs, which are typically made of a relatively stiff, yet flexible material, are used to position the pig in the pipeline. At the same time, the cuffs serve to control the flow, around the pig, of the fluid flowing through the pipeline, or use this to drive the pig forward in the pipeline.

The ultrasonic sensors used to examine pipelines are selected on the basis of certain parameters, such as e.g. the pipeline diameter, the pipeline wall thickness or media properties, and then are arranged and oriented on the pig. A variety of possible parameter combinations obviously exists, which has a direct influence on, inter alia, the required types of fixing for the mechanical sensors. The associated large number of different mechanical parts entails a significant development effort and high costs.

It would therefore be desirable to reduce the complexity and lower the development effort and costs.

### SUMMARY OF THE INVENTION

One aspect of the invention relates to a segment for a sensor-carrier body of a pig for inspecting a pipeline, said sensor-carrier body consisting of at least one segment, wherein the segment has a supporting structure, on which at least one bar including at least one ultrasonic transducer is arranged, wherein the at least one bar is releasably fastened to the supporting structure.

The placement and orientation of the ultrasonic transducers is therefore defined by a separate, releasably fastened bar and not, as is customary, directly on the supporting structure itself. As a result, different types of bars for different pipeline wall thicknesses (e.g. type A bars for a wall thickness of 5 mm, type B bars for 10 mm, etc.) can be kept in stock to enable a quick changeover by swapping the type of bar.

In this context, “releasably fastened” may mean that the bar can be mechanically released from the supporting structure without being destroyed. By way of example, the bar is fastened to the supporting structure by means of at least one connecting element, such as a screw for example. In some examples, the bar and the supporting structure may be in direct contact. As an alternative or in addition, it is possible that the bar and the supporting structure are in direct contact with a connecting element, by means of which the bar and the supporting structure are connected.

It is possible that multiple bars are releasably fastened to each supporting structure. By way of example, at least two, in particular at least three or at least four or at least eight bars are in each case fastened to a supporting structure.

The supporting structure may be of one-piece design. Alternatively, the supporting structure may consist of multiple parts, which in each case directly adjoin one another.

With particular preference, the at least one bar is fastened to the supporting structure via an interface, it being possible for the interface to be a predefined or consistent interface. As a result, it is possible that one supporting structure can be used for different types of bars having this interface.

The interface may consist of a matching shape, in which case the bar has a first shape in one portion and the supporting structure has a matching second shape in one portion, so that, when the bar is applied to the supporting structure, the first shape fits together with the second shape and ensures that the bar is securely seated on the supporting structure. The first shape and the second shape may be configured such that the supporting structure forms a frame, in particular a mechanical frame, for the bar. By way of example, the first shape is a depression and/or a recess. The second shape may be an elevation. The first shape is preferably a depression with inclined side walls and a flat bottom. The second shape is preferably an elevation with oppositely inclined side walls and a flat top, so that the second shape can be inserted into the first shape with a precise fit to ensure a firm and secure hold.

The supporting structure may in particular have a depression and/or recess, in particular multiple depressions and/or recesses. The depression (or recess) may be designed and/or shaped to receive and hold the bar. In the case of multiple depressions (or recesses), each of the depressions (or recesses) may be designed to receive and hold in each case one bar including ultrasonic transducers. By way of example, the supporting structure forms a frame, in particular a mechanical frame, for the bar. It is possible that the supporting structure surrounds the bar in the manner of a frame.

When using such a predefined, consistent interface for multiple types of bar, each of these types of bar can be mounted on different supporting structures in different pigs or pipeline sizes and used for a corresponding measuring task.

In some examples, the segment may comprise skids, in particular two skids. In the case of exactly two skids, these may be substantially parallel to each other. The skids may be formed in one piece with the supporting structure or may be releasably connected to the supporting structure. The skids may project beyond the supporting structure, for example in a normal direction. The skids may have the function of a spacer relative to a pipeline to be inspected. By way of example, the skids bear against the inner wall of the pipeline when the pig is in operation, which makes it possible to guide the sensors at a desired distance from the inner wall. The supporting structure and the at least one ultrasonic transducer may be arranged between the skids.

Preferably, the at least one bar has in each case at least one receptacle, which in each case is designed to receive an ultrasonic transducer in a defined orientation. These are preferably ultrasonic transducers which can emit ultrasound in a preferred direction defined by the geometry of the transducer and receive it from this direction. In this case, the defined orientation when inserting the transducer into the bar ensures that ultrasonic signals can be emitted and received in a specific direction.

The bar thus defines the orientation of the ultrasonic transducers, with the combination of bar(s) and supporting structure defining the orientation and distribution of the ultrasonic transducers and thus the area of application and the measuring task.

As already mentioned, this reduces the effort required to adapt to a new inspection task/environment. In particular, the supporting structure is independent of the respective measuring task and can therefore be retained and/or does not have to be adjusted. In addition, the claimed invention offers the possibility of mixing different types of bar with one another in order to expand the area of application and/or to enable special applications in which different sensor orientations have to be used.

Preferably, the at least one bar has a preferably flat surface with a normal. In this case, the at least one ultrasonic transducer is arranged on the respective sensor bar in such a way that the at least one ultrasonic transducer can emit a signal in a direction differing from the normal and/or can receive a signal from a direction differing from the normal. As an alternative or in addition, the at least one ultrasonic transducer can emit a signal in a normal direction and/or receive a signal from a normal direction.

With particular preference, the at least one sensor bar has a respective (preferably flat) surface with a normal and includes a first ultrasonic transducer and a second ultrasonic transducer, wherein the first ultrasonic transducer is designed to emit a signal in a first direction and the second ultrasonic transducer is designed to receive a signal from a second direction, the first direction and the second direction being situated in one plane.

Preferably, the plane in which the first direction and the second direction are situated includes the normal.

Preferably, the first direction is inclined by an angle of +α relative to the normal and the second direction is inclined by an angle of −α relative to the normal. Preferably 0≤α<90°, and particularly preferably 0<α<90°.

In one particularly preferred embodiment, at least two ultrasonic transducers are arranged on the sensor bar.

In another particularly preferred embodiment, at least two bars are arranged on the supporting structure, each of the bars preferably being equipped with at least two ultrasonic transducers.

A second aspect of the present invention relates to the use of a segment according to the first aspect in a pig for inspecting a pipeline.

A third aspect of the present invention relates to a pig for inspecting a pipeline, said pig having at least one segment according to the first aspect.

The segment may have the properties and features described above, either alone or in combination.

### BRIEF DESCRIPTION OF THE FIGURES

Exemplary embodiments of the invention will be described below with reference to the following figures:

FIG. 1 shows a pig 10 in a pipeline 12 to be inspected, said pig comprising a sensor-carrier body 14 which has a plurality of segments 16 according to the first aspect of the invention;

FIG. 2a and FIG. 2b show schematic diagrams of a segment according to the first aspect of the invention;

FIG. 3 shows an exemplary supporting structure 18 without bars 20 mounted thereon;

FIG. 4 shows, in an exploded view, a bar 20 equipped with ultrasonic transducers 22;

FIG. 5 shows an exemplary beam path during use in inspecting pipelines;

FIG. 6 shows a segment 16 comprising one supporting structure 18 and eight bars 20;

FIG. 7 shows a segment 16 during use in a pipeline 12.

### DETAILED DESCRIPTION

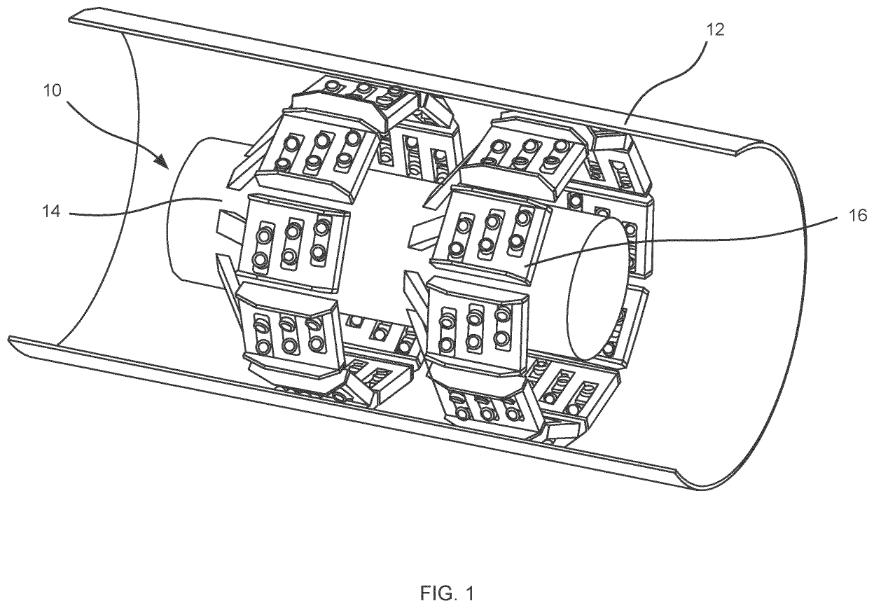

FIG. 1 shows a pig 10 in a pipeline 12 to be inspected, said pig comprising a sensor-carrier body 14 which has a plurality of segments 16 according to the first aspect of the invention.

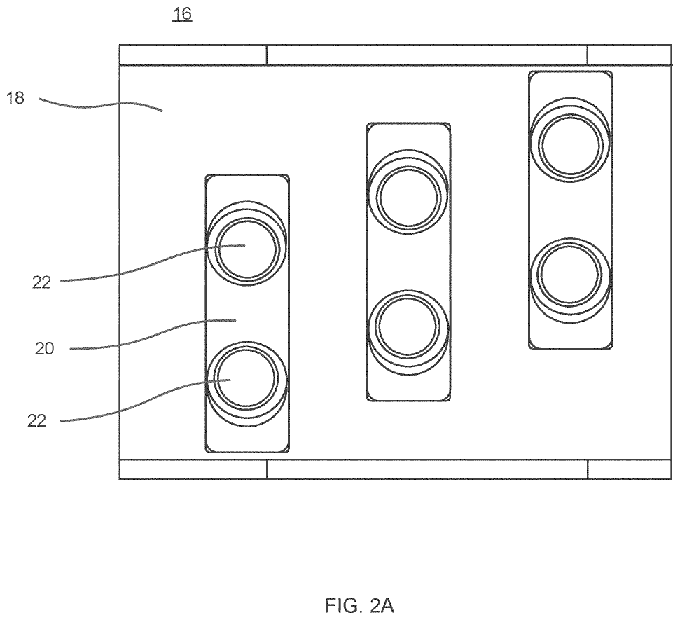

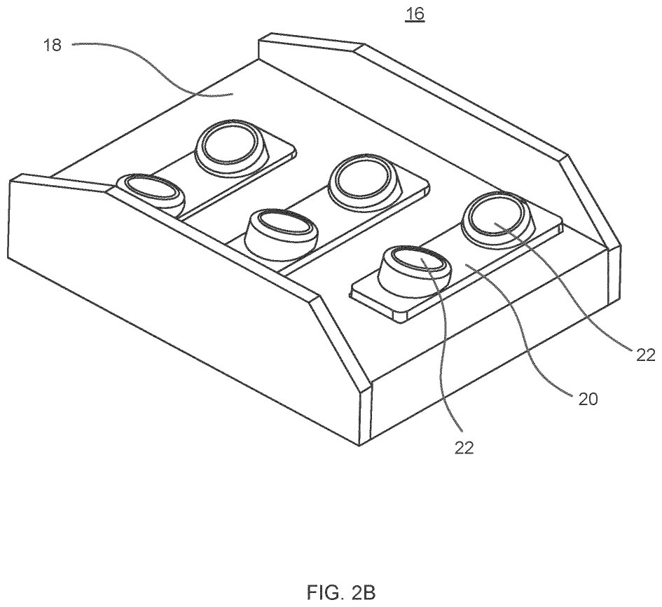

One of the segments 16 is shown schematically in the plan view according to FIG. 2a. The segment 16 comprises one supporting structure 18, on which three bars 20 are mounted, each of the bars 20 including two ultrasonic transducers 22. As can be seen in FIG. 2a and in particular FIG. 2b, the two ultrasonic transducers 22 of each bar 20 are inclined toward each other, so that the respective emission and reception direction thereof differs from the normal to the surface of the bar 20 by the same angle with opposite signs. It can be seen that the bars 20 are arranged offset from one another. Specifically, the bars 20 are arranged offset from one another in their longitudinal direction, which corresponds to the direction in which the two ultrasonic transducers 22 are arranged in each bar 20. As a result, when the segment 16 is in use, each segment 16 achieves greater coverage of the pipeline inner wall to be inspected.

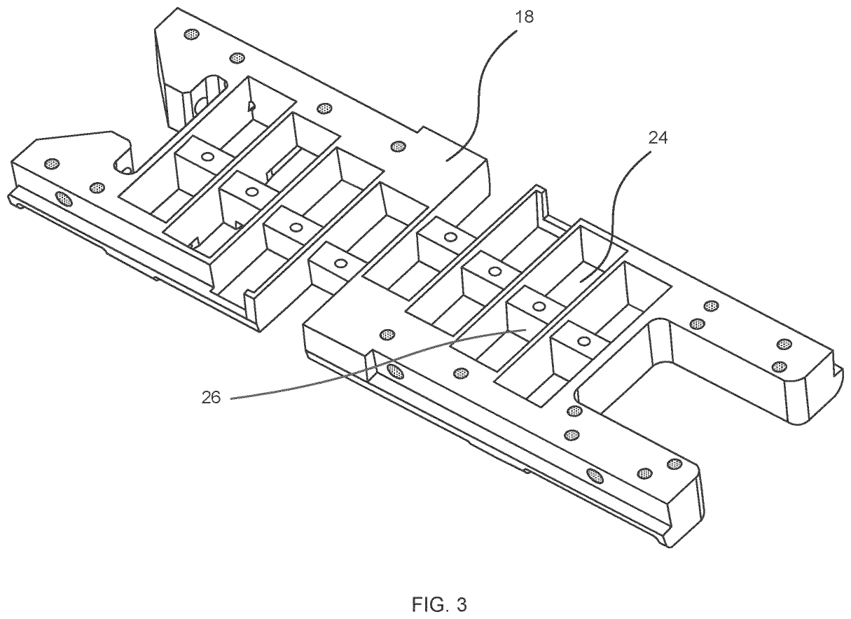

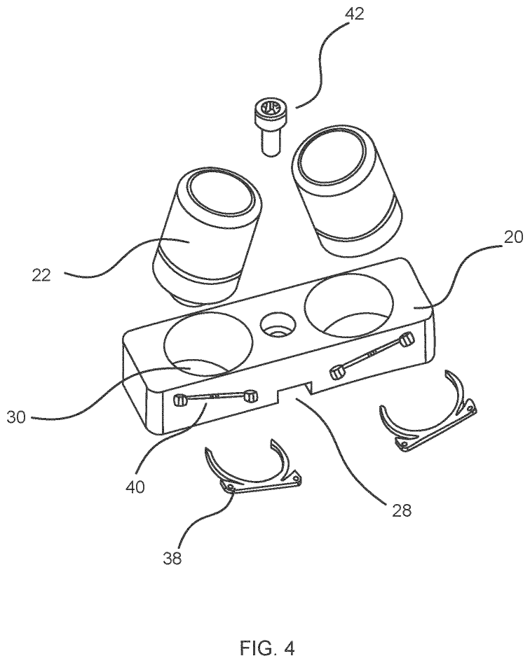

FIG. 3 shows an exemplary supporting structure 18 without bars 20 mounted thereon. The supporting structure 18 forms a mechanical frame having in this case eight depressions or recesses 24, wherein each of the recesses 24 is designed and shaped to receive and hold a bar 20 including ultrasonic transducers 22. For this purpose, each of the eight recesses 24 shown includes a connecting element 26. The connecting element 26 has a shape which matches an inversely shaped interface 28 of a bar 20 (cf. FIG. 4), so that the bar 20 can be secured to the supporting structure 18 as a result of the interface 28 of the bar 20 cooperating with the connecting element 26 in a form-fitting manner.

An exemplary bar 20 according to the first aspect of the present invention is shown in the exploded view according to FIG. 4. The bar 20 has two receptacles 30, into each of which an ultrasonic transducer 22 can be inserted in a specific orientation. By way of example, as indicated in FIG. 4, a clamp 38 may be used to fasten the ultrasonic transducer 22 in one of the receptacles 30. The clamp 38 can be inserted into a slot 40, which is designed to correspond to the inclination relative to the normal of the surface of the bar 20 and thus to the orientation of the ultrasonic transducer 32, until it engages in a corresponding circumferential groove on the ultrasonic transducer 22 and thus secures the ultrasonic transducer 22 to the bar 20.

A screw 42 can be used to releasably fasten the bar 20 to the supporting structure. To this end, the bar 20 has, between the two receptacles 30, a through-hole which extends in the direction of the normal of the surface of the bar 20. The hole becomes narrower in a stepped fashion, so that the screw 42 can be inserted into the hole and sunk with its head therein. Provided at a suitable location in the connecting element 26 is a corresponding threaded hole, into which the screw 42 can be screwed, as indicated in FIG. 3.

As can be seen from the figures, the two ultrasonic transducers 22 of a bar 20 are inclined toward each other in such a way that the emission and reception directions of the two ultrasonic transducers 22 (i) differ from the normal to the surface of the bar 20 and (ii) are situated in a plane that includes the normal. With particular preference, the emission/reception direction of one ultrasonic transducer 22 forms an angle other than zero with the normal, while the emission/reception direction of the other ultrasonic transducer 22 forms the opposite or negative angle with the normal.

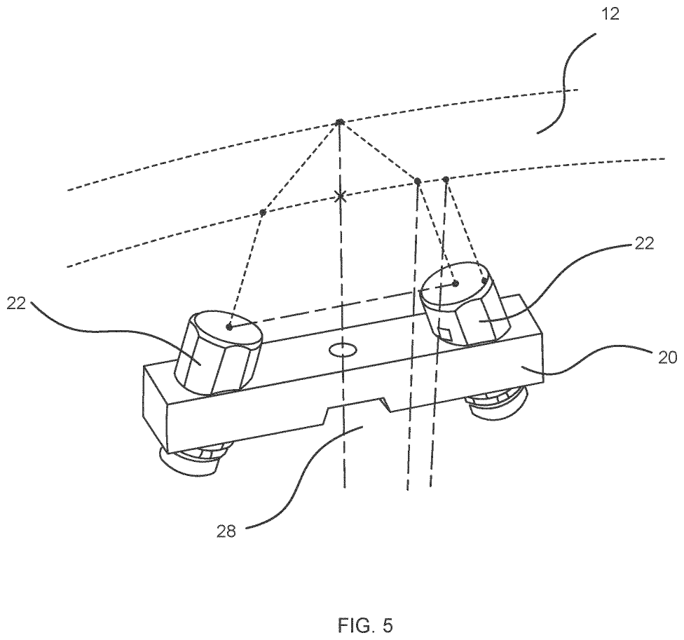

An ultrasonic signal emitted by the first ultrasonic transducer 22 is thus directed in direct reflection from a pipeline wall arranged at a suitable distance h directly toward the other, second ultrasonic transducer 22, as indicated in FIG. 5. However, the two ultrasonic transducers 22 may also be arranged further apart from each other than would be required by direct reflection from a pipeline wall arranged at a distance h, for example in order to detect ultrasonic modes propagating in the pipeline, which only exit from the pipeline again after a certain distance therein.

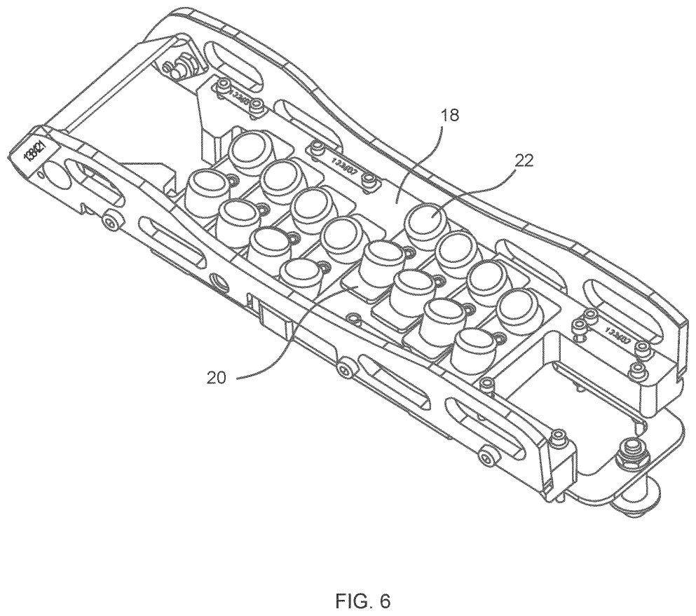

FIG. 6 shows a segment 16 comprising one supporting structure 18 and eight bars 20. The bars 20 are each equipped with two ultrasonic transducers 22 which are inclined toward each other. The bars 16 are fitted into a respective recess 24 and are individually securely connected in a form-fitting manner, via their respective interface 28, to the connecting element 26 of the respective recess 24 of the supporting structure 18, which is located therebelow. In addition, the bars 20 are releasably fastened to the supporting structure 18 by a respective screw 42, as also described above.

As shown in FIG. 6, the bars 20 are arranged offset from one another in order to be able, when used to inspect a pipeline, to sonicate and examine, using ultrasonic signals, as large an area of the pipeline wall as possible. Due to the predefined interface 28, which is the same for all bars 20, the segment 16 can quickly and easily be equipped with different bars 20 and thus with different or differently oriented ultrasonic transducers 22.

The supporting structure 18 is fastened to the segment 16 by means of further screws, as shown in FIG. 6. The segment 16 is mounted (not shown) on the sensor-carrier body 14 and thus on the pig 10 via the screw connection shown at the right-hand, lower edge of FIG. 6.

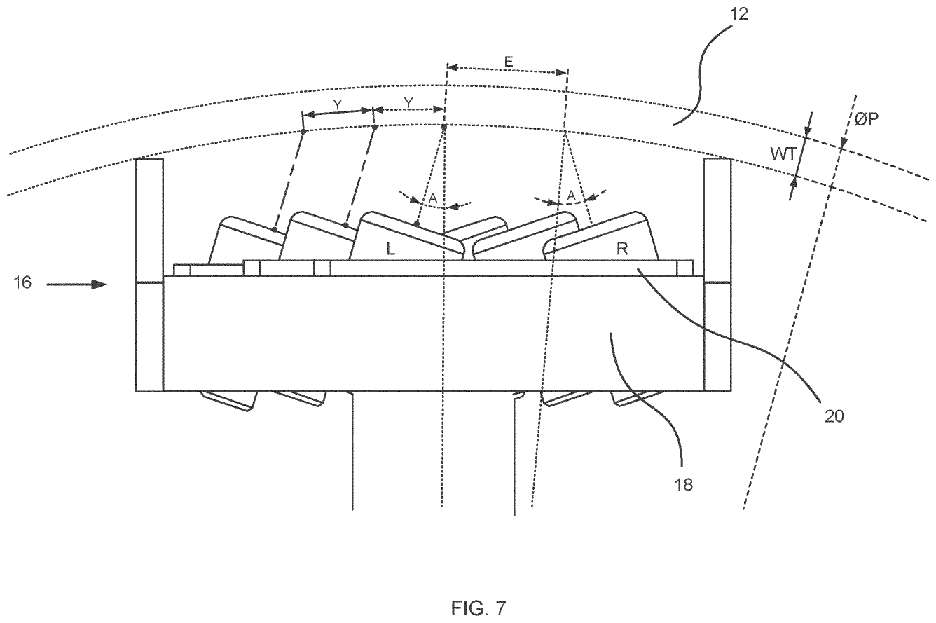

FIG. 7 shows the sonication and detection of the ultrasonic signals reflected by the pipeline 12 when using a segment 16 according to the invention to inspect a pipeline 12. As described above, multiple bars 20 are mounted on the supporting structure 18 of the segment 16, each bar including two ultrasonic transducers 22 which are inclined toward each other, one on the right and one on the left, which are therefore denoted R and L in FIG. 7, where WT is the wall thickness of the pipeline 12, @P is the external diameter of the pipeline 12, and A is the angle of inclination of the transducer 22 relative to the normal. As a result, the emission/reception angle of the two ultrasonic transducers 22 of such a pair is equal (except for the sign), as indicated in FIG. 7.

1. A segment for a sensor-carrier body of a pig for inspecting a pipeline, comprising a supporting structure, on which at least one bar including at least one ultrasonic transducer is arranged, wherein the at least one bar is releasably fastened to the supporting structure.

2. The segment according to claim 1, wherein the at least one bar has a predefined interface, via which the bar is fastened to the supporting structure.

3. The segment according to claim 2, wherein the predefined interface has a shape that matches an inverse shape on the supporting structure in such a way that the shape of the interface cooperates with the inverse shape on the supporting structure to ensure that the bar is securely seated on the supporting structure.

4. The segment according to claim 1, wherein the at least one bar has in each case at least one receptacle, which in each case is designed to receive an ultrasonic transducer in a defined orientation.

5. The segment according to claim 1, wherein the at least one bar has a respective surface with a normal, and the at least one ultrasonic transducer is arranged on the respective bar in such a way that the at least one ultrasonic transducer can emit a signal in a direction differing from the normal and/or can receive a signal from a direction differing from the normal.

6. The segment according to claim 1, wherein the at least one bar has a respective surface with a normal and includes a first ultrasonic transducer and a second ultrasonic transducer, wherein the first ultrasonic transducer is designed to emit a signal in a first direction and the second ultrasonic transducer is designed to receive a signal from a second direction, the first direction and the second direction being situated in one plane.

7. The segment according to claim 6, wherein the plane includes the normal.

8. The segment according to claim 6 or 7, wherein the first direction is inclined by an angle of +α relative to the normal and the second direction is inclined by an angle of −α relative to the normal.

9. The segment according to claim 1, wherein at least two ultrasonic transducers are arranged on the bar.

10. The segment according to claim 1, wherein at least two bars are arranged on the supporting structure, each bar including at least two ultrasonic transducers.

11. The segment according to claim 1, wherein the supporting structure includes depressions and/or recesses which are designed and shaped to receive the bar.

12. The segment according to claim 1, wherein the supporting structure forms a mechanical frame for the bar.

13. The segment according to claim 5, wherein the supporting structure includes depressions and/or recesses which are designed and shaped to receive the bar, and wherein the supporting structure forms a mechanical frame for the bar.

14. A pig for inspecting a pipeline comprising a sensor-carrier body having at least one segment according to claim 1.

15. A method for inspecting a pipeline for defects comprising using a segment according to claim 1.

16. A method for inspecting a pipeline for defects comprising using a pig according to claim 14.
